(19) United States
(12) Patent Application Publication
(10) Pub. No.: US 2024/0026255 A1
(43) Pub. Date: Jan. 25, 2024

(54) METHOD OF REMOVING IMPURITIES IN DESIGN ALCOHOLIC BEVERAGES

(71) Applicant: Yakov Shteyman, Brooklyn, NY (US)

(72) Inventor: Yakov Shteyman, Brooklyn, NY (US)

(21) Appl. No.: 18/481,885

(22) Filed: Oct. 5, 2023

Related U.S. Application Data
(63) Continuation-in-part of application No. 17/988,437, filed on Nov. 16, 2022, now abandoned.
Application No. 17/988,437 is a continuation of application No. 16/409,160, filed on May 10, 2019, now abandoned.

(51) Int. Cl. C12H 1/07; C02F 1/52; C12G 3/08

(52) U.S. Cl. CPC C12H 1/063; C02F 1/52; C12G 3/08

(57) ABSTRACT

A method for removing a set of impurities in an alcoholic beverage is described herein. The steps comprise providing a water solution including approximately 96% or less, of pure water and at least 4% or more of honey by volume, creating a mixture from approximately 50% the water solution by volume and approximately 50% by volume of a spirit base that includes a set of impurities and at least 80% alcohol by volume, adding approximately 1% of a set of extracts by volume to the resultant product to achieve desired taste, adding approximately 4% or more of a sugar by volume, and and adding approximately 0.5% of a sediment by volume to create two phase colloidal mixture and catalyze sedimentation, adsorbing the set of impurities into the sediment, and separating the sediment from the resultant product.

### CROSS-REFERENCE TO RELATED APPLICATIONS

This application is a continuation in part application of U.S. application Ser. No. 17/988,437, filed Nov. 16, 2022, which is a continuation U.S. application Ser. No. 16/409,160, filed May 10, 2019, which claims priority to U.S. Provisional Application No. 62/670,356, filed May 11, 2018. Each of these patent applications is incorporated herein by reference in its entirety to provide continuity of disclosure.

### FIELD OF THE INVENTION

The present invention relates to food and beverage processing. In particular, the present invention relates to processing alcoholic beverages by removing contaminants and impurities and achieving desirable designed taste and aroma of beverage by adding variable plant extracts.

### BACKGROUND OF THE INVENTION

Alcoholic beverages, in particular distilled spirits, begin with a fermentation process, which converts sugars into cellular energy thereby producing ethanol and carbon dioxide. Another byproduct of fermentation is fusel oil produced by amino acids during the fermentation and distillation process.

Fusel oil is a mixture of volatile organic acids, higher alcohols, aldehydes, ketones, fatty acids, and esters, including amyl alcohol and n-propyl and isobutyl alcohols. When concentrated, this mixture has an oily consistency and potent odor. During distillation, fusel oil is typically concentrated in the feints or “tails” at the end of the distillation run. Fusel oil can affect the flavor and aroma of the resultant beverage. For example, fusel oil can give off a solvent-like aroma and flavor. Moreover, in certain beverages such as vodka the presence of fusel oil, in addition to alcohols other than ethanol, is considered a fault. As a result, removal of these impurities including fusel oil is desirable.

One proposed method employs nanofiltration and ultrafiltration to filter out the fusel oil. However, this method is limited to rice spirits and requires additional costs in the form of additional pumps, valves, gauges, and temperature control systems, in addition to the routine costs of filters.

Therefore, there is a need in the art for a method for removing impurities, including fusel oil, in a wide range of alcoholic beverages without additional costs and maintenance and in a quick manner to minimize costs.

### SUMMARY

A method for removing a set of impurities in an alcoholic beverage is disclosed. In one embodiment, the steps include providing a water solution comprising approximately 96%, or less, of pure water and at least 4% or more of honey by volume, providing a spirit base comprising a set of impurities and at least 80% alcohol by volume, creating a mixture from approximately 50% the water solution by volume and approximately 50% the spirit base by volume, adding approximately 1% of a set of extracts by volume to the mixture to achieve designer taste, adding approximately 4% or more of sugar by volume and approximately 0.5% or more of sediment to create two phase colloidal mixture, adsorbing the set of impurities onto the sediments, and separating the sediment from the resultant product. After separation of the two phases, the sediment contains impurities such as fusel oil, and yields a clear liquid final product suitable for consumption without additional purification.

### BRIEF DESCRIPTION OF THE DRAWINGS

In the detailed description presented below, reference will be made to the following drawing.

FIG. 1 is a flowchart of a method for creating a sediment for removing impurities in alcoholic beverages of a preferred embodiment.

FIG. 2 is a flowchart of a method for removing impurities in alcoholic beverages of a preferred embodiment.

### DETAILED DESCRIPTION

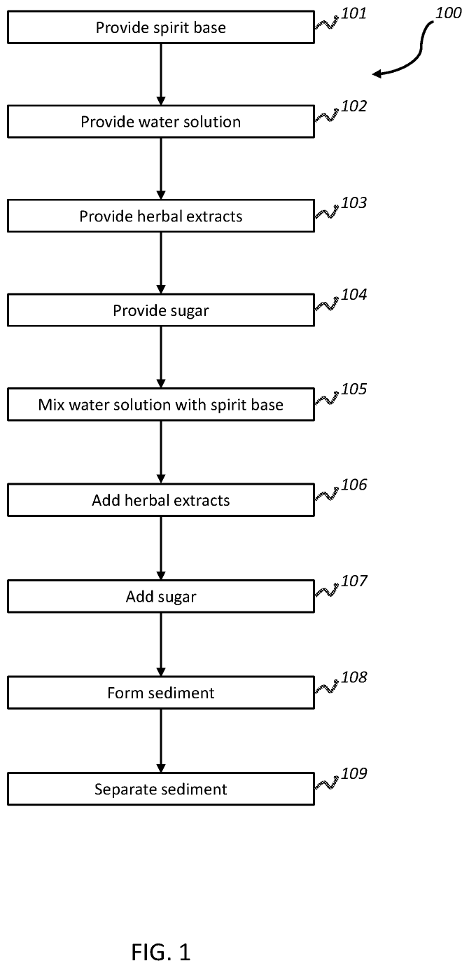

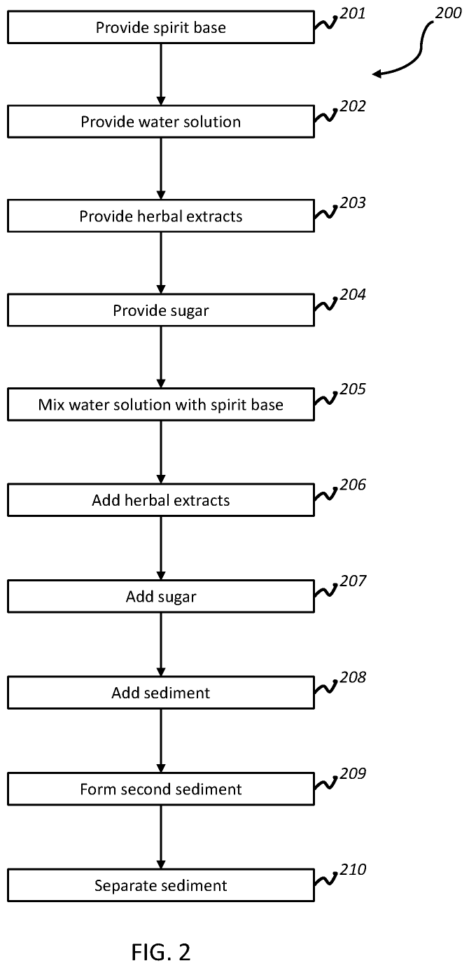

Referring to FIG. 1, method 100 for creating a sediment used in removing impurities in alcoholic beverages is described. Referring to FIG. 2, method 200 for removing impurities in alcoholic beverages using sediment created by method 100. In a preferred embodiment, any suitable mixing equipment known in the art may be used to perform these methods.

Method 100 begins at step 101, where a spirit base is provided. In a preferred embodiment, the spirit base is any alcohol suitable for human consumption having at least eighty percent (80%) alcohol by volume (160 proof in the United States), that is mixed with equal amounts of a water solution as described below. For example, the spirit base is a clear high point alcohol such as vodka, rum, gin, or tequila. The components for a spirit base having at least eighty percent (80%) alcohol by volume is described in Table 1 below.

TABLE 1
Spirit Base Components

| | Amount |
|---|---|
| Components | (in approximate percentage by volume) |
| Water | 19% or less |
| Alcohol | 80% or more |
| Contaminants (Fusel Oil, etc.) | Up to and including 1% |

At step 102, a water solution is provided. In a preferred embodiment, the water solution is a mixture of water and honey in the amounts described in Table 2 on the following page.

TABLE 2
Water Solution Components

| | Amount |
|---|---|
| Components | (in approximate percentage by volume) |
| Water | Up to and including 96% |
| Honey | 4% or more |

In a preferred embodiment, the water solution includes approximately up to and including 96% water by volume, approximately 4% or more of honey by volume.

At step 103, a herbal extract is provided. In a preferred embodiment, the set of extracts is extract of walnut dividers, or also known as the partition. The walnut divider is the portion inside of the walnut shell that separates the kernel or “meat” inside the walnut shell. In other embodiments, the set of extracts is a set of fruit extracts that include any number of desired fruits and/or plants. For example, pineapple, or hot pepper extract (for example Pimiento roja.), or various herbs (for example anise) extract. Any type of fruit extract may be employed as desired. In other embodiments, a set of herbal extracts is employed. In a preferred embodiment, the set of herbal extracts is tincture extracts. Other known herbal extracts may be employed as desired.

At step 104, a sugar is provided. In a preferred embodiment, the sugar is ordinary granulated sugar.

At step 105, the water solution is mixed with the spirit base at a ratio of approximately fifty percent (50%) water solution by volume to approximately fifty percent (50%) spirit base. This step is performed using any suitable mixing equipment known in the art. In a preferred embodiment, the mixture of the water solution and the spirit base has an alcohol content of approximately forty percent (40%) alcohol by volume (80 proof in the United States). In a preferred embodiment, the mixture of the water solution and the spirit base is agitated for approximately one (1) hour.

At step 106, the herbal extracts are added to to the mixture of the water solution and the spirit base. In a preferred embodiment, approximately one percent (1%) or more of a set of extracts by volume is added to the resultant product.

At step 107, the sugar is added to the mixture of the water solution, spirit base, and herbal extract for sedimentation. This step is performed using any suitable mixing equipment known in the art. In one embodiment, approximately 4% or more of sugar by volume is added to the mixture. In this embodiment, the mixture of the water solution and the spirit base is agitated continuously for approximately twenty-four (24) hours or until the sugar dissolves.

At step 108, sedimentation occurs and sediment forms in the mixture of the water solution and spirit base. In this step, impurities such as fusel oil are adsorbed on the sediment as it forms. In a preferred embodiment, the sedimentation process takes place over one or more weeks.

At step 109, the sediment is separated by pouring off the liquid, leaving behind the sediment. This sediment can be used to catalyze further sedimentation in the purification process.

Method 200 begins at step 201, where a spirit base is provided. In a preferred embodiment, the spirit base is any alcohol suitable for human consumption having at least eighty percent (80%) alcohol by volume (160 proof in the United States), that is mixed with equal amounts of a water solution as described below. For example, the spirit base is a clear high point alcohol such as vodka, rum, gin, or tequila. The components for a spirit base having at least eighty percent (80%) alcohol by volume is described in Table 3 on the following page.

TABLE 3
Spirit Base Components

| | Amount |
|---|---|
| Components | (in approximate percentage by volume) |
| Water | 19% or less |
| Alcohol | 80% or more |
| Contaminants (Fusel Oil, etc.) | Up to and including 1% |

At step 202, a water solution is provided. In a preferred embodiment, the

water solution is a mixture of water and honey in the amounts described in Table 4 below.

TABLE 4
Water Solution Components

| | Amount |
|---|---|
| Components | (in approximate percentage by volume) |
| Water | Up to and including 96% |
| Honey | 4% or more |

In a preferred embodiment, the water solution includes approximately up to and including 96% water by volume, approximately 4% or more of honey by volume.

At step 203, a herbal extract is provided. In a preferred embodiment, the set of extracts is extract of walnut dividers, or also known as the partition. The walnut divider is the portion inside of the walnut shell that separates the kernel or “meat” inside the walnut shell. In other embodiments, the set of extracts is a set of fruit extracts that include any number of desired fruits and/or plants. For example, pineapple, or hot pepper extract (for example Pimiento roja.), or various herbs (for example anise) extract. Any type of fruit extract may be employed as desired. In other embodiments, a set of herbal extracts is employed. In a preferred embodiment, the set of herbal extracts is tincture extracts. Other known herbal extracts may be employed as desired.

At step 204, a sugar is provided. In a preferred embodiment, the sugar is ordinary granulated sugar.

At step 205, the water solution is mixed with the spirit base at a ratio of approximately fifty percent (50%) water solution by volume to approximately fifty percent (50%) spirit base. This step is performed using any suitable mixing equipment known in the art. In a preferred embodiment, the mixture of the water solution and the spirit base has an alcohol content of approximately forty percent (40%) alcohol by volume (80 proof in the United States). In a preferred embodiment, the mixture of the water solution and the spirit base is agitated for approximately one (1) hour.

At step 206, the herbal extracts are added to to the mixture of the water solution and the spirit base. In a preferred embodiment, approximately one percent (1%) or more of a set of extracts by volume is added to the resultant product.

At step 207, the sugar is added to the mixture of the water solution and the spirit base for sedimentation. This step is performed using any suitable mixing equipment known in the art. In one embodiment, approximately 4% or more of sugar by volume is added to the mixture.

At step 208, approximately 0.5% or more per unit volume of sediment, obtained through Method 100 or through Method 200, is added, and the mixture is agitated to suspend the sediment in the mixture for efficient separation. This creates a colloidal mixture which catalyzes sedimentation. This step is performed using any suitable mixing equipment known in the art. In one embodiment, the mixture is agitated continuously for approximately twenty-four (24) hours or until the sugar dissolves.

At step 209, sedimentation occurs and sediment forms in the mixture of the water solution and spirit base. In this step, impurities such as fusel oil are adsorbed on the sediment. In a preferred embodiment, the sedimentation process takes place for approximately one day, depending on how long it takes for the sediment to fully separate out.

At step 210, the sediment is separated from the resultant product by pouring off the liquid, leaving behind the sediment. The resultant product has been purified and impurities such as fusel oil removed from the resultant product. The extracted sediment can then be further used to catalyze sedimentation of further execution of Method 200.

It will be appreciated by those skilled in the art that modifications can be made to the embodiments disclosed and remain within the inventive concept. Therefore, this invention is not limited to the specific embodiments disclosed, but is intended to cover changes within the scope and spirit of the claims.

1. A method for removing impurities comprising the steps of:
creating a mixture from approximately 50% a water solution by volume and approximately 50% a spirit base by volume;
adding at least approximately 4% or more of sugar by volume to the mixture;
adding at least approximately 0.5% of a first sediment by volume to the mixture;
suspending the first sediment in the mixture to form a resultant product;
creating a second sediment from the first sediment; and,
separating the first and second sediment from the resultant product to form a final product.

2. The method of claim 1, further comprising the step of creating the first sediment.

3. The method of claim 2, wherein the step of creating the first sediment comprises:
creating a mixture from approximately 50% a water solution by volume and approximately 50% a spirit base by volume;
adding at least approximately 1% of a set of extracts by volume to the resultant product;
adding at least approximately 4% or more of sugar by volume to the mixture;
suspending the sugar in the mixture;
allowing sedimentation to occur, forming sediment in the mixture; and,
separating the sediment from the mixture.

4. The method of claim 1, wherein the step of suspending the sugar in the mixture to form a resultant product in providing the sediment further comprises the step of agitating the mixture for approximately twenty-four (24) hours or more.

5. The method of claim 1, further comprising the step of adding at least approximately 1% of a set of extracts by volume to the mixture.

6. The method of claim 1, further comprising the step of providing a spirit base having at least 80% alcohol by volume as the spirit base.

7. The method of claim 1, further comprising the step of creating the water solution from approximately 96% or less of water by volume and from approximately 4% or more of honey by volume.

8. The method of claim 1, further comprising the step of providing approximately 4% or more of ordinary granulated sugar by volume as the sugar.

9. The method of claim 1, wherein the step of suspending the sediment in the mixture to form a resultant product further comprises the step of agitating the mixture for approximately twenty-four (24) hours or more.

10. The method of claim 1, wherein the step of separating the first sediment and the second sediment from the resultant product to form a final product is performed by pouring off the liquid to leave behind said first sediment and second sediment.

11. A method for removing a set of impurities comprising the steps of:
providing a water solution comprising from approximately 96% or less of water and from approximately 4% or more of honey by volume;
providing a spirit base comprising a set of impurities and at least 80% alcohol by volume;
creating a mixture from approximately 50% of said water solution by volume and approximately 50% of said spirit base by volume;
adding at least approximately 4% or more of sugar by volume to the mixture;
adding at least approximately 0.5% of a first sediment by volume to the mixture;
suspending the first sediment in the mixture to form a resultant product;
creating a second sediment from the first sediment; and,
separating the first and second sediment from the resultant product to form a final product.

12. The method of claim 11, further comprising the step of creating the first sediment.

13. The method of claim 12, wherein the step of creating the first sediment comprises:
creating a mixture from approximately 50% a water solution by volume and approximately 50% a spirit base by volume;
adding at least approximately 1% of a set of extracts by volume to the resultant product;
adding at least approximately 4% or more of sugar by volume to the mixture;
suspending the sugar in the mixture;
allowing sedimentation to occur, forming sediment in the mixture; and,
separating the sediment from the mixture.

14. The method of claim 11, further comprising the step of adding at least approximately 1% of a set of extracts by volume to the mixture.

15. The method of claim 11, wherein the step of suspending the sugar in the mixture to form a resultant product in providing the sediment further comprises the step of agitating the mixture for approximately twenty-four (24) hours or more.

16. The method of claim 11, wherein the step of suspending the sediment in the mixture to form a resultant product further comprises the step of agitating the mixture for approximately twenty-four (24) hours or more.

17. The method of claim 11, wherein the step of separating the first sediment and the second sediment from the resultant product to form a final product is performed by pouring off the liquid to leave behind said first sediment and second sediment.
